(19) United States
(12) Patent Application Publication
(10) Pub. No.: US 2023/0055396 A1
(43) Pub. Date: Feb. 23, 2023

(54) ENERGY DISSIPATION PADS

(71) Applicant: SWG RED LLC, Jupiter, FL (US)

(72) Inventors: Daryoush Allaei, Minneapolis, MN (US); Benjamin Reydel, Mahwah, NJ (US); James Rall, Mahwah, NJ (US)

(73) Assignee: SWG RED LLC, Jupiter, FL (US)

(21) Appl. No.: 17/820,334

(22) Filed: Aug. 17, 2022

Related U.S. Application Data
(60) Provisional application No. 63/234,546, filed on Aug. 18, 2021.

(51) Int. Cl. F16F 3/087

(52) U.S. Cl. CPC F16F 3/0873

(57) ABSTRACT

Energy dissipation pads are described herein. In one aspect, a system can include an airdrop load; and at least one energy-dissipation assembly having a grid formed from a plurality of boards each including a plurality of slots sufficient to accommodate a thickness of others of the plurality of boards and form a plurality of joints; where at least one of the at least one energy-dissipation assemblies is positioned below or within the airdrop load such that the grid of the energy-dissipation assembly is at least partially perpendicular to an anticipated impact vector.

### CROSS-REFERENCE TO RELATED APPLICATIONS

This application claims the benefit of priority under 35 U.S.C. § 119(e) from U.S. Provisional patent application Ser. No. 63/234,546, filed Aug. 18, 2021. The entire content of each of these applications is hereby incorporated by reference herein.

### STATEMENT REGARDING FEDERALLY SPONSORED RESEARCH OR DEVELOPMENT

This invention was made with government support under contract number: FA86492000146 awarded by the U.S. Air Force. The government has certain rights in the invention.

### BACKGROUND OF THE INVENTION

Energy dissipation pads can be implemented for the transporting and/or paradropping of shipping items. The energy dissipation pads can be placed under the shipping items, on the sides of the shipping items, and on top of the shipping items, and can provide a surface for the shipping items to be placed or to be surrounded by.

### SUMMARY

Energy dissipation pads are described herein. In one aspect, a system can include an airdrop load; and at least one energy-dissipation assembly having a grid formed from a plurality of boards each including a plurality of slots sufficient to accommodate a thickness of others of the plurality of boards and form a plurality of joints; where at least one of the at least one energy-dissipation assemblies is positioned below or within the airdrop load such that the grid of the energy-dissipation assembly is at least partially perpendicular to an anticipated impact vector.

This aspect can include a variety of embodiments. In one embodiment, the plurality of boards can include an elastomer.

In another embodiment, the plurality of slots can include three slots.

In another embodiment, the plurality of slots are defined by a surface of a respective board.

In another embodiment, the plurality of slots are defined by different surfaces of the respective board.

In another embodiment, a shape of each of the plurality of slots are uniform between each other.

In another embodiment, a width-defining surface of a board of the plurality of boards defines one or more apertures.

In another embodiment, a board of the plurality of boards further includes one or more air pockets.

In another embodiment, a board of the plurality of boards further includes one or more metal-filled pockets.

In another embodiment, the plurality of joints includes halved joints.

In another aspect, a method can include positioning at least one energy-dissipation assembly including a grid formed from a plurality of boards each including a plurality of slots sufficient to accommodate a thickness of others of the plurality of boards and form a plurality of joints below or within the airdrop load such that the grid of the energy-dissipation assembly is at least partially perpendicular to an anticipated impact vector.

In another aspect, a modular energy-dissipation pad can include a plurality of elastomeric boards; where the plurality of elastomeric boards each include a plurality of slots sufficient to accommodate a thickness of others of the plurality of elastomeric boards and form a plurality of joints; and the plurality of elastomeric boards can be assembled to form at least one polygon.

This aspect can include a variety of embodiments. In one embodiment, the plurality of elastomeric boards can be assembled to form a grid. In some cases, the grid can be a square grid. In some cases, the grid can be a 2×2 rectangular grid. In some cases, the grid can be a rectangular grid. In some cases, the grid can be a triangular grid.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 depicts a board for an energy dissipation pad according to an embodiment of the present disclosure.

FIGS. 2-6 depict energy dissipation pad configurations according to embodiments of the present disclosure.

FIGS. 7A-8B depict individual boards for an energy dissipation pad according to embodiments of the present disclosure.

### DEFINITIONS

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

### Energy Dissipation Pad

Energy dissipation pads are described herein. The energy dissipation pad can be an elastomer-based, modular, and adaptable. The energy dissipation pad can be assembled by the packager, which allows for reduced shipping volumes of separate pieces as well as decreased storage volume. The energy dissipation pad can include individual pieces with multiple slits that combine to make a larger assembly, namely pods.

The energy dissipation pad has several advantages over traditional energy dissipation pad. The design allows for smaller shipping volume (prior to assembly), can be assembled on-site, and is reusable. The use of elastomer material allows for its reusability and makes the pad impervious to environmental conditions including, but not limited to, moisture (which, in addition to potentially reducing performance or lifespan of a traditional paper honeycomb pad, increases weight, which impacts the effective cargo capacity and/or range of an airplane carrying the pad. One assembly of the energy dissipation pad can be used for well over a five-year's worth of shipping items.

### Boards

The energy dissipation pad can include a plurality of individual boards. The boards can be configured for coupling to one another to form the energy dissipation pad. For example, each board can each define a number of slots along a given surface of the board. The board can be configured for receiving another board within a defined slot. In some cases, the board can be configured to receive a corresponding slot defined by another board.

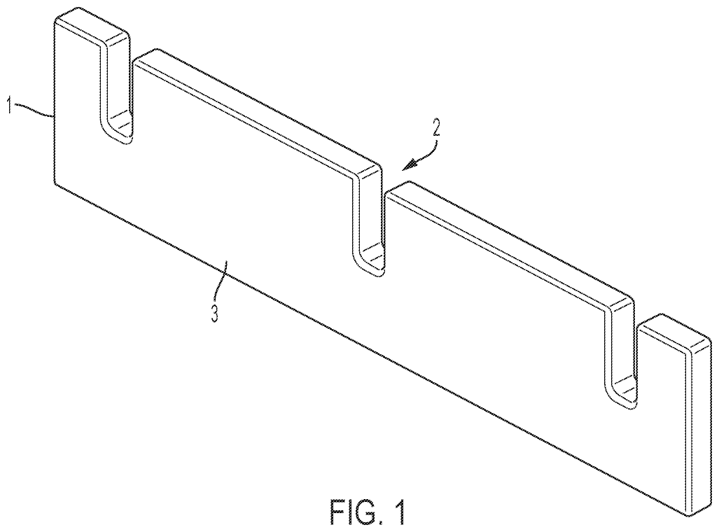

FIG. 1 depicts an individual board 1 for the energy dissipation pad according to embodiments of the present disclosure. The board 1, as shown, can have a generally rectangular shape. However, one skilled in the art will understand that the general shape of the board 1 can vary based on the overall desired shape and configuration of the energy dissipation pad. For example, the board 1 can, in some cases, be square, polygonal, oval, triangular, trapezoidal, and the like, in profile.

The board 1 can include a number of slots 2 defined along a respective surface of the board 1. In some cases, the defined shape of a slot 2 can be configured for receiving a corresponding slot of another board, or an unslotted portion of another board. Thus, the shape of a slot 2 can vary based on the desired configuration of the energy dissipation pad. For example, in the examples discussed with reference to the figures, the impact vector of coupling two boards together via slots are perpendicular to the length of the board. However, the impact vector need not be perpendicular, and may be dependent on the shape of the corresponding slot(s). Further, the defined shape of the slots 2 can be uniform across the board 1, or may vary across the slots 2 of the board 1. In some cases, the overall depth of the defined slot may be up to half the depth of the board 1 (e.g., the half joints shown in FIG. 1). Example dimensions of the board 1 can be of 12″×3″×0.5″ and three slots. However, the overall dimensions, number of slots, and the material formulation can be adjusted based on application. For example, increasing the number of slots can turn add more individual boards to a pad, which can strengthen the system for heavy loads.

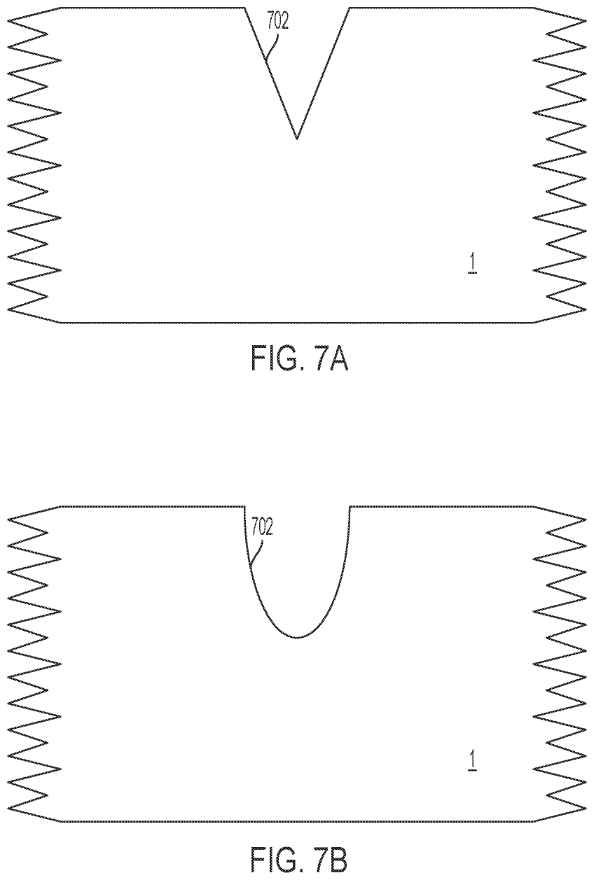

Slots 2 can have substantially rectangular profiles as depicted in FIG. 1. In other embodiments, slots 702 can have tapered profiles such as the linear taper depicted in FIG. 7A or the curved (e.g., parabolic) taper depicted in FIG. 7B. Such a tapered profile (e.g., in cooperation with an adjoining tapered profile) can promote jamming of the boards 1 into the tapered slots 702 to absorb additional energy. Such jamming can be further promoted when the combined depth of adjoining tapered slots 702 is less than the height H of a single board. In such an embodiment, the outer (i.e., top and bottom) surfaces of the assembled pad will only include a subset of the boards 1, which allows for the bearing boards to move inward by jamming upon impact. Jammed slots may also resist rebounding upward upon after impact.

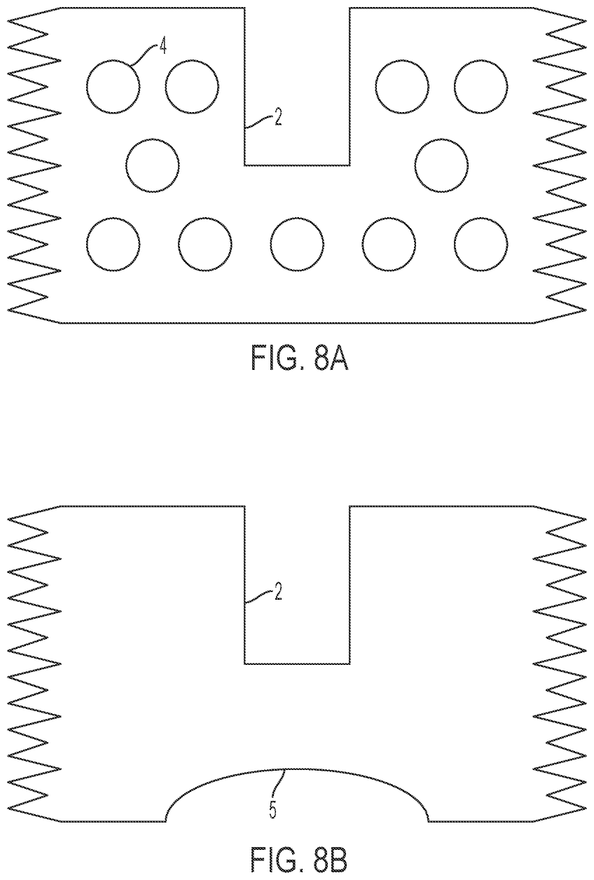

In some cases, other apertures may be defined by the board 1 apart from the slots 2. For example and as depicted FIG. 8A, the board 1 may include a set of apertures 4 defined by the board 1. The apertures 4 may reduce the overall weight of the board 1, thereby reducing the overall weight of the resulting energy dissipation pad. In some cases, the apertures may be punched, drilled, or machined from the board 1 post-manufacturing. In some cases, the apertures 4 may be formed during manufacturing of the board 1 (e.g., the board mold can include the defined apertures 4). In another embodiment depicted in FIG. 8B, the edge(s) of the board 1 include scallops 5 to reduce weight and/or facilitate deflection to absorb energy.

### Assembly

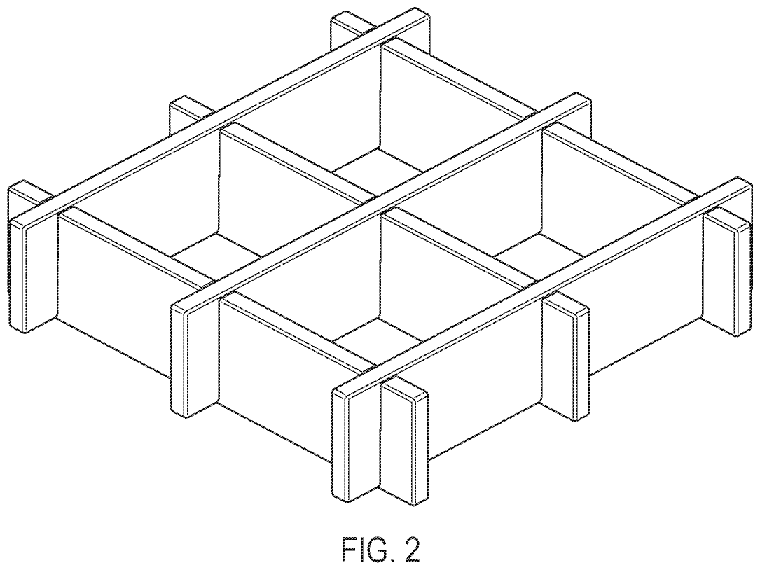

FIGS. 2-6 depict different configurations of an energy dissipation pad according to embodiments of the present disclosure. The energy dissipation pads can be assembled (e.g., by a user manually) by coupling a board to another individual board, for example, by sliding a slot of a board into a corresponding slot of another board. FIG. 2 depicts a total of 6 boards coupled to one another to form a square grid. Each board of FIG. 2 is an example of the board 1 of FIG. 1, which includes 3 slots 2. Further, the slot depth for each board in this example allows for the coupled boards to form smooth assembled surfaces across the assembled energy dissipation pad, which can assist in uniform energy transfer across the pad.

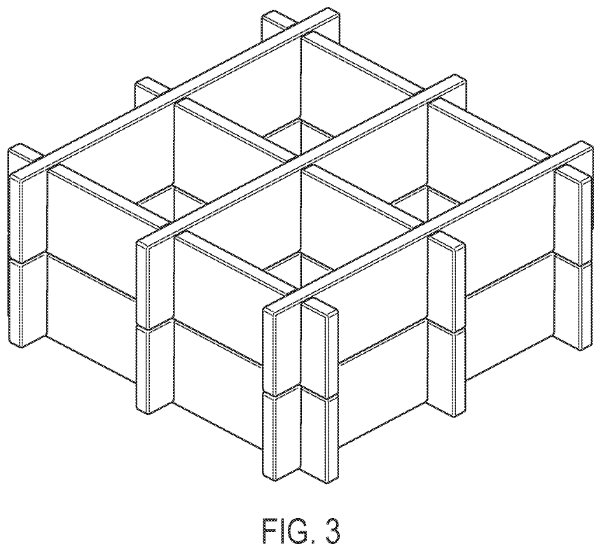

FIG. 3 depicts two square grids (e.g., such as that depicted in FIG. 2) stacked on top of one another. This assembly can be accomplished by forming the two square grids separately and then stacking one on top of the other. In some cases, the grids can be coupled to one another post stacking. For example, the boards of one grid can be configured to receive of couple to the boards of the other grid (e.g., via defined slots or protrusions of the boards). In some cases a layer of material (e.g., a sheet good such as cardboard, hardboard, plywood, oriented-strand board (OSB), and the like) can be placed between the stacked grids. In some cases, the layer of material can be of the same composition as the boards. The layer can in some cases increase the overall energy transfer characteristics of the assembled pad. In some cases, the layer can assist in coupling the grids to each other (e.g., having a high friction coefficient to reduce movement between the stacked grids).

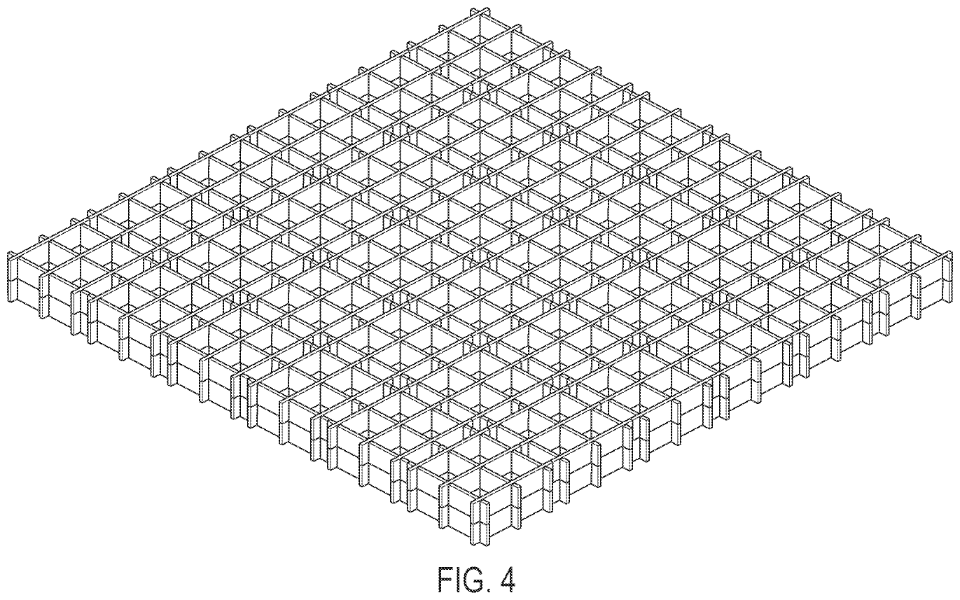

FIG. 4 depicts a plurality of square grids positioned side-by-side to form a larger square grid. The grids can be positioned adjacent to each other. In some cases, the grids can be coupled to one another, for example, the boards of one grid can be configured to receive of couple to the boards of the other grid (e.g., via defined slots or protrusions of the boards).

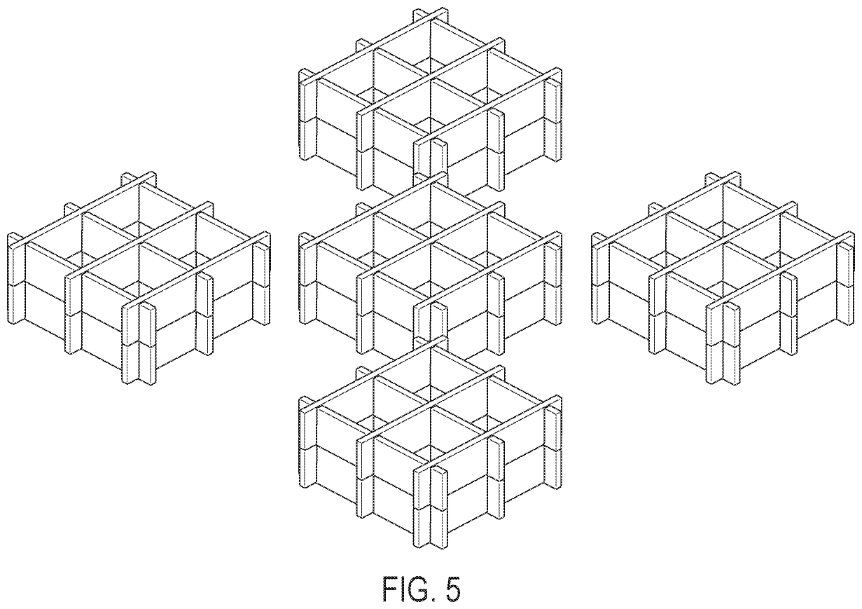

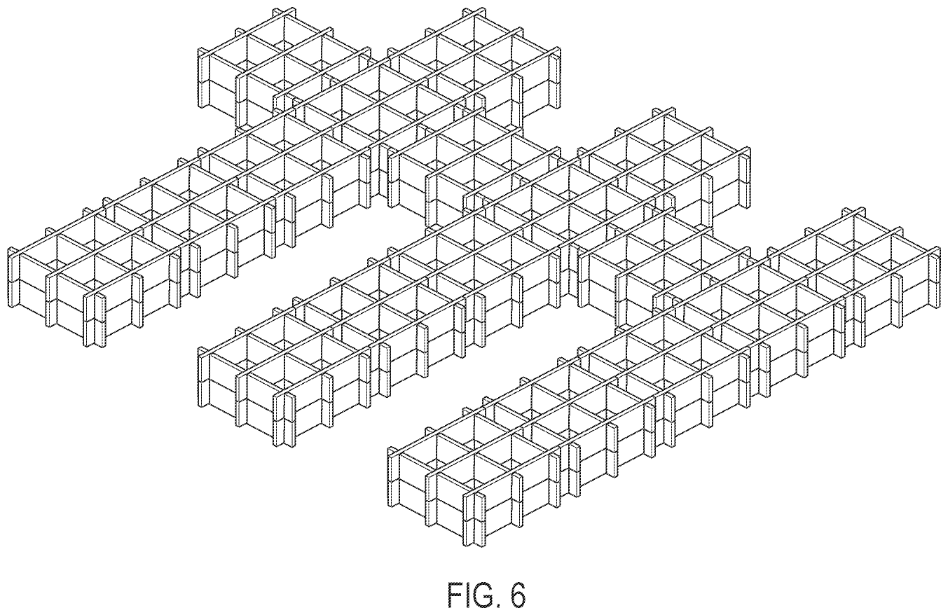

FIGS. 5 and 6 illustrate different configurations highlighting the versatility of the energy dissipation pads described herein. As can be seen, the configurations can vary based on the desired shape of a user. The number of grids used, as well as the positioning of each grid, can be dependent on the desired shape and characteristics of the resulting energy dissipation pad. For example, the configuration depicted in FIG. 5 can be implemented in scenarios where the desired energy dissipation qualities of the pad are uniform, yet the pad is also desired to be as light as possible (e.g., thus, the voids left between the individual grids). The configuration in FIG. 6 can be implemented in scenarios where the intended payload to be placed on top of the energy dissipation pad has unique dimensions or uneven weight distributions.

### Compositions

The boards of the energy dissipation pad can be composed of different compositions. For example, the boards can be composed of an elastomeric material. The elastomeric material can include a polymer such as a polyolefins (e.g., polyethylene, polypropylene, polymethylpentene, polybutene-1, polyisobutylene, ethylene propylene rubber, ethylene propylene diene rubber, and the like), acrylonitrile-butadiene rubber, hydrogenated acrylonitrile-butadiene rubber, fluorocarbon rubber, perfluoroelastomer, silicone rubber, fluorosilicone rubber, chloroprene rubber, neoprene rubber, polyester urethane, polyether urethane, natural rubber, polyacrylate rubber, ethylene acrylic, styrene-butadiene rubber, ethylene oxide epichlorodrine rubber, chlorosulfonated polytethylene, butadiene rubber, isoprene rubber, butyl rubber, and the like. In some cases, plastic or metals can be used as part of the composition. In some cases, the boards can be filled with air pockets (e.g., during the manufacturing process) to further reduce weight, and may improve the ability of the energy dissipation pad to float in water. In some cases, the boards can be filled with pockets of metal, or some other dense material (e.g., during the manufacturing process), which can improve the ability of the energy dissipation pad to sink in water. Additionally, boards may be impregnated with pockets composed of air, or other fluid. The pockets can modify the buoyancy of the energy dissipation pad. The pockets can impact the performance characteristics of the energy dissipation pad as well.

Other materials can be utilized such as cardboard and wood (e.g., dimensional lumber, hardboard, plywood, OSB, and the like)

In some cases, the composition can mitigate the overall weight of the energy dissipation pads (e.g., compared to conventional pads), can increase energy transfer through the pad, can facilitate the maintaining of the structural integrity of the pad (e.g., thereby allowing for multiple uses), and can be weather-resistant.

### Minimizing Rebound Energy

Embodiments of the invention can include one or more features designed to minimizing rebound energy after impact, which could damage the cargo, e.g., by causing it to rotate on its side.

In some embodiment, the boards 1 and/or the pad includes one or more frangible members that break upon impact to dissipate energy.

In other embodiments, the pads can include a mechanical device adapted and configured to allow compression, but retard rebounding. For example, a piston can quickly compress downward past ratcheting teeth that engage when the piston is pulled outward by rebound energy in a board to which the piston is attached. The ratcheting teeth can be attached to a spring (e.g., a leaf spring, coil spring, a spiral spring, a volute spring, and the like).

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A system comprising:
an airdrop load; and
at least one energy-dissipation assembly comprising a grid formed from a plurality of boards each comprising a plurality of slots sufficient to accommodate a thickness of others of the plurality of boards and form a plurality of joints;
wherein at least one of the at least one energy-dissipation assemblies is positioned below or within the airdrop load such that the grid of the energy-dissipation assembly is at least partially perpendicular to an anticipated impact vector.

2. The system of claim 1, wherein the plurality of boards comprise an elastomer.

3. The system of claim 1, wherein the plurality of slots comprises three slots.

4. The system of claim 1, wherein the plurality of slots are defined by a surface of a respective board.

5. The system of claim 1, wherein the plurality of slots are defined by different surfaces of the respective board.

6. The system of claim 1, wherein a shape of each of the plurality of slots are uniform between each other.

7. The system of claim 1, wherein a width-defining surface of a board of the plurality of boards defines one or more apertures.

8. The system of claim 1, wherein a board of the plurality of boards further comprises one or more air pockets.

9. The system of claim 1, wherein a board of the plurality of boards further comprises one or more metal-filled pockets.

10. The system of claim 1, wherein the plurality of joints comprises halved joints.

11. A method comprising:
positioning at least one energy-dissipation assembly comprising a grid formed from a plurality of boards each comprising a plurality of slots sufficient to accommodate a thickness of others of the plurality of boards and form a plurality of joints below or within the airdrop load such that the grid of the energy-dissipation assembly is at least partially perpendicular to an anticipated impact vector.

12. A modular energy-dissipation pad comprising:
a plurality of elastomeric boards;
wherein:
the plurality of elastomeric boards each comprise a plurality of slots sufficient to accommodate a thickness of others of the plurality of elastomeric boards and form a plurality of joints; and
the plurality of elastomeric boards can be assembled to form at least one polygon.

13. The modular energy-dissipation pad of claim 12, wherein the plurality of elastomeric boards can be assembled to form a grid.

14. The modular energy-dissipation pad of claim 13, wherein the grid is a square grid.

15. The modular energy-dissipation pad of claim 13, wherein the grid is a 2×2 rectangular grid.

16. The modular energy-dissipation pad of claim 13, wherein the grid is a rectangular grid.

17. The modular energy-dissipation pad of claim 13, wherein the grid is a triangular grid.
